(19) United States
(12) Patent Application Publication
(10) Pub. No.: US 2017/0039055 A1
(43) Pub. Date: Feb. 9, 2017

(54) SOFTWARE APPLICATION PACKAGING AND DEPLOYMENT SYSTEM

(71) Applicant: Bank of America Corporation, Charlotte, NC (US)

(72) Inventors: Jagadish Kumar Uppal, Hyderabad (IN); Manoj Pollam, Secunderabad (IN); Sunil Devagupthapu, Secunderabad (IN)

(21) Appl. No.: 14/818,530

(22) Filed: Aug. 5, 2015

(51) Int. Cl. G06F 9/445; G06F 3/0484; G06F 17/30; G06F 3/0481

(52) U.S. Cl. CPC G06F 8/62; G06F 3/04817; G06F 3/04842; G06F 17/30138; G06F 8/61

(57) ABSTRACT

Methods for software application packaging are provided. Methods may include receiving a software application and a list of entity-specific software standards. Methods may also include transforming, by a packaging system of the software application into a packaged software application. The transforming may include evaluating the behavior of the software application. The transforming may include engineering the software application to satisfy the entity-specific software standards identified as relevant. The transforming may include storing the software application in a file. The transforming may include compressing the file which stores the software application. The transforming may include truncating the filename of a portion of binary files included in the software application file. The transforming may include executing a computer-readable script and thereby transforming the software application into a packaged software application. Methods may also include transmitting and installing the packaged software application on a plurality of desktop computers.

### FIELD OF TECHNOLOGY

This invention relates to software applications. Specifically, this application relates to packaging and deploying legacy software applications, Microsoft Windows installer and virtual packages.

### BACKGROUND OF THE DISCLOSURE

Many entities utilize computers in various geographical locations. Numerous, diverse software applications may run on the computers.

The entities may operate with entity-specific regulations. The entity-specific regulations may include software regulations.

In order to ensure that each software application complies with the entity-specific regulations, there is a need for a software packaging system. The software packaging system may preferably package a software application. The packaging system may preferably disable software application functions that do not comply with the entity-specific regulations. The software packaging system may preferably install the packaged software applications on applicable computers.

### SUMMARY OF THE INVENTION

An apparatus for application packaging software is provided. The apparatus may include a receiver. The receiver may be configured to receive a software application. The receiver may also be configured to receive a list of entity-specific software standards.

The apparatus may also include a packaging system. The packaging system may enable transformation of the software application into a packaged software application. The packaged software application may be in the form of a wrapper application. The wrapper application may be compiled into a legacy executable format (.exe), a Microsoft Windows Installer package format and/or a virtual package format. The transforming may include evaluating the software application. The evaluating may include identifying whether read and/or write permissions are required by a user of the software application. The evaluating may also include identifying a network bandwidth required to install the software application on the user's computer within a predetermined time frame. The network bandwidth may be measured in bits per second (“bps”).

Modern networks typically operate at speeds measured in millions of bits per second and billions of bits per second. The evaluating may include identifying system requirements required to operate the software application. The system requirements may include a specific processor. The system requirements may also include a minimum number of bytes of hard drive. The evaluating may also include identifying which entity-specific software standards, included in a plurality of entity-specific software standards, are related to the software application.

The transforming of the software application into a packaged software application may also include engineering the software application to satisfy the entity-specific software standards which were identified as relevant. The engineering may include identifying which modifications may be needed to satisfy the entity-specific software standards. The modifications may be implemented on the software application. The implementation of the modifications may cause the software application to comply with the entity-specific standards.

The engineering may also include generating a computer-readable script. The computer-readable script, when executed, may modify the software application. Upon completion of the execution, the software application may conform to the entity-specific standards. The computer-readable script may be a Wise script file (.wse), an Internet research project file (.irp), an Install shield project file (.ism), a Visual basic script file (.vbs), a Powershell script (.psl), a batch script file (.cmd or .bat) or any other suitable file.

The transforming may include storing the software application in a file. The transforming may also include compressing the file. The compressing may reduce the size of the file. The transforming may also include truncating the filename of binary files included in the software application file. The truncating may be applied to filenames of binary files that have a character length greater than 256. The transforming may include executing the computer-readable script. The executing may transform the software application into a packaged software application.

The apparatus may also include a transmitter. The transmitter may be configured to transmit the packaged software application to a plurality of desktop computers. The plurality of desktop computers may each be located in a remote location with respect to the packaging system. The plurality of desktop computers may also be located in a location adjacent to the packaging system. Some computers, among the plurality of desktop computers may be located in remote location with respect to the packaging system, and some computers may be located adjacent to the packaging system.

The apparatus may also include one or more processors. The processors may be configured to install the packaged software application on the plurality of desktop computers. The installation may be transparent to a user. The installation may not be transparent to the user.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows an illustrative apparatus in accordance with principles of the invention;

FIG. 2 shows an illustrative apparatus in accordance with principles of the invention;

FIG. 3 shows an illustrative graphical user interface (“GUI”) in accordance with an embodiment of the invention;

FIG. 4 shows an illustrative GUI in accordance with an embodiment of the invention;

FIG. 5 shows an illustrative GUI in accordance with an embodiment of the invention;

FIG. 6 shows illustrative computer-readable pseudo-code in accordance with an embodiment of the invention;

FIG. 7 shows illustrative computer-readable pseudo-code in accordance with an embodiment of the invention;

FIG. 8 shows illustrative computer-readable pseudo-code in accordance with an embodiment of the invention;

FIG. 9 shows illustrative computer-readable pseudo-code in accordance with an embodiment of the invention;

FIG. 10 shows illustrative computer-readable pseudo-code in accordance with an embodiment of the invention;

FIG. 11 shows illustrative computer-readable pseudo-code in accordance with an embodiment of the invention;

FIG. 12 shows illustrative computer-readable pseudo-code in accordance with an embodiment of the invention;

FIG. 13 shows illustrative computer-readable pseudo-code in accordance with an embodiment of the invention;

FIG. 14 shows illustrative computer-readable pseudo-code in accordance with an embodiment of the invention;

FIG. 15A shows illustrative computer-readable pseudo-code in accordance with an embodiment of the invention;

FIG. 15B shows illustrative computer-readable pseudo-code in accordance with an embodiment of the invention;

FIG. 16 shows illustrative computer-readable pseudo-code in accordance with an embodiment of the invention;

FIG. 17 shows an illustrative Command Line Interface (“CLI”) in accordance with an embodiment of the invention;

FIG. 18 shows an illustrative CLI in accordance with an embodiment of the invention;

FIG. 19 shows an illustrative CLI in accordance with an embodiment of the invention;

FIG. 20 shows an illustrative GUI in accordance with an embodiment of the invention;

FIG. 21 shows an illustrative GUI in accordance with an embodiment of the invention;

FIG. 22 shows an illustrative GUI in accordance with an embodiment of the invention;

FIG. 23 shows illustrative pseudo-code in accordance with an embodiment of the invention; and

FIG. 24 shows an illustrative flow chart in accordance with the principles of the invention.

### DETAILED DESCRIPTION OF THE DISCLOSURE

An apparatus for application packaging software is provided. The apparatus may include a receiver. The receiver may be configured to receive a software application. The receiver may also be configured receive a list of entity-specific software standards.

In some embodiments, the software application may not be compatible with Windows 7 and Windows 8 operating systems. The entity-specific software standards may ensure compatibility of the software application with Windows 7 and Windows 8 operating systems.

In some embodiments, the software application may be non-compliant with regulatory compliance issues. The entity-specific software standards may ensure compliance of the software application with the regulatory compliance issues.

The apparatus may also include a packaging system. The packaging system may enable transformation of the software application into a packaged software application. The transforming may include evaluating the behavior of the software application. The evaluating may include identifying what hardware and/or software resources the software application requires to operate. The evaluating of the software application may include identifying whether read and/or write permissions are required by a user of the software application. There may be some files, included in the software application, that may require read and write permissions. There may be some files, included in the software application, that may require read-only permission. There may be some files, included in the software application, that may require write-only permission. There may be some files, included in the software application, that require neither read nor write permissions.

The evaluating may also include identifying a network bandwidth required to install the software application on a computer within a predetermined time frame. The evaluating may also include identifying system requirements required to operate the software application. The evaluating may also include identifying which entity-specific software standards, included in the plurality of entity-specific software standards, are related to the software application.

The transforming of the software application into a packaged software application may include engineering the software application to satisfy the entity-specific software standards which were identified as relevant. The engineering may include identifying modifications which, when implemented, cause the software application to comply with the entity-specific standards.

The modifications may include registry changes. Lockdown of registry settings, policy changes and licensing changes may be included in registry changes that may require modification.

The engineering may include generating a computer-readable script. Upon execution, the computer-readable script may modify the software application. The modification may cause the software application to conform to the entity-specific standards.

The transforming may include storing the software application in a file. The transforming may include storing the software application in a plurality of files.

The transforming may include compressing the file, or plurality of files, that store the software application. The compressing may reduce the size of the file or of the plurality of files. Compressing the file, or plurality of files, may enable faster transmission of the file. Compressing the file may also reduce network bandwidth required to transmit the file. Reduction in network bandwidth proportionally reduces traffic on a network.

The transforming may also include truncating the filename of binary files included in the software application file. The truncating may be executed on binary files with a filename that has a character length greater than 256. The truncating of the filename may enable the files to be processed through Microsoft® System Center Configuration Manager 2012 (“Microsoft SCCM 2012”). Microsoft SCCM 2012 is a program for offering solutions for managing data center resources, private clouds and client services. Microsoft SCCM 2012 may have a processing limitation of 32 bytes on a filename of a binary file. In other versions of Microsoft SCCM, there may be other limitations on the filenames of binary files. In those instances, the packaging system may truncate or lengthen the filenames as appropriate.

The packaging system may include executing the computer-readable script. The executing may transform the software application into a packaged software application. The execution may be performed on one instance of a software application. The packaged software application may be copied for each computer where the software application is required.

The apparatus may also include a transmitter. The transmitter may be configured to transmit the packaged software application to a plurality of desktop computers. The plurality of desktop computers may be located in a remote location with respect to the packaging system. In some embodiments, the plurality of desktop computers may be located adjacent to the packaging system. In other embodiments, a portion of the plurality of computers may be located remote from the packaging system, while other computers may be located adjacent to the packaging system.

The apparatus may also include one or more processors. The processors may be configured to install the packaged software application on the plurality of desktop computers. In certain embodiments, the installation may be deployed “silently”—i.e., transparent to a user of a desktop computer. In those embodiments, the parameter “/s” may be passed to the setup.exe file together with the install, uninstall, or extract parameter. The parameters “/s/install” may be passed to the setup.exe file for silent installation of a virtual package, msi packages or wrapper packages. The parameters “/s/uninstall” may be passed to the setup.exe file for silent uninstallation of a virtual package, msi package or wrapper package. The parameters “/s/extract” may be passed to the setup.exe file for silent extraction scripts, configuration files or key files from a virtual file, msi package or wrapper package.

The installation may include an executable setup file. The executable setup file may be accessible via a command line interface. The executable setup file may also be accessible via a GUI interface. The executable setup file may also be accessible via any other suitable interface.

The installation may include placement of a shortcut icon on each desktop computer, included in the plurality of desktop computers. The shortcut icon may enable a user of the packaged software application to initialize the packaged software application via a selection of the shortcut icon.

The packaging system may also enable uninstallation of the packaged software application. The uninstallation may be deployed via the executable software application. The uninstallation may be initialized via a command line interface, a GUI, a run interface or any other suitable interface.

The packaging system may also store the computer-readable script or other important configuration files in an extractable folder in the software application. The storing of the computer-readable script or other important configuration files in an extractable folder may enable extraction of the script in an event where the script or other important configuration files were lost, corrupted or otherwise became inaccessible because of some other unforeseen reason. The storing of the computer-readable script in an extractable folder may enable extraction of the script or other important configuration files in an event where the script or other important configuration files requires updating. The packaging system may enable a user to extract the computer-readable script or other important configuration files from the software application. The extraction may be performed via a command line interface, GUI or any other suitable interface.

The executable setup file may accept parameters. The parameter may be entered via a command line interface. The parameters may include install, uninstall and extract. Upon receipt of the parameter install by the executable setup file on a command line interface, or any other suitable interface, the executable setup file may be configured to execute an installation computer-readable script. The installation computer-readable script may install the software application on a desktop computer. Upon receipt of the parameter install by the executable setup file on a command line interface or any other suitable interface, the executable setup file may be configured to execute installation.

Upon receipt of the parameter uninstall by the executable setup file on the command line interface, or any other suitable interface, the executable file may be configured to execute an uninstallation computer-readable script. The uninstallation computer-readable script, when executed, may uninstall the software application on a desktop computer. Upon receipt of the parameter uninstall by the executable setup file on the command line interface, or any other suitable interface, the executable setup file may be configured to execute uninstallation.

Upon receipt of the parameter extract by the executable file on the command line interface, or any other suitable interface, the executable setup file may be configured to execute an extraction computer-readable script or other important configuration files. When the extraction computer-readable script is executed, the executable setup file may extract the computer-readable script or other important configuration files from the packaged software application.

Illustrative embodiments of apparatus and methods in accordance with the principles of the invention will now be described with reference to the accompanying drawings, which form a part hereof. It is to be understood that other embodiments may be utilized and structural, functional and procedural modifications may be made without departing from the scope and spirit of the present invention.

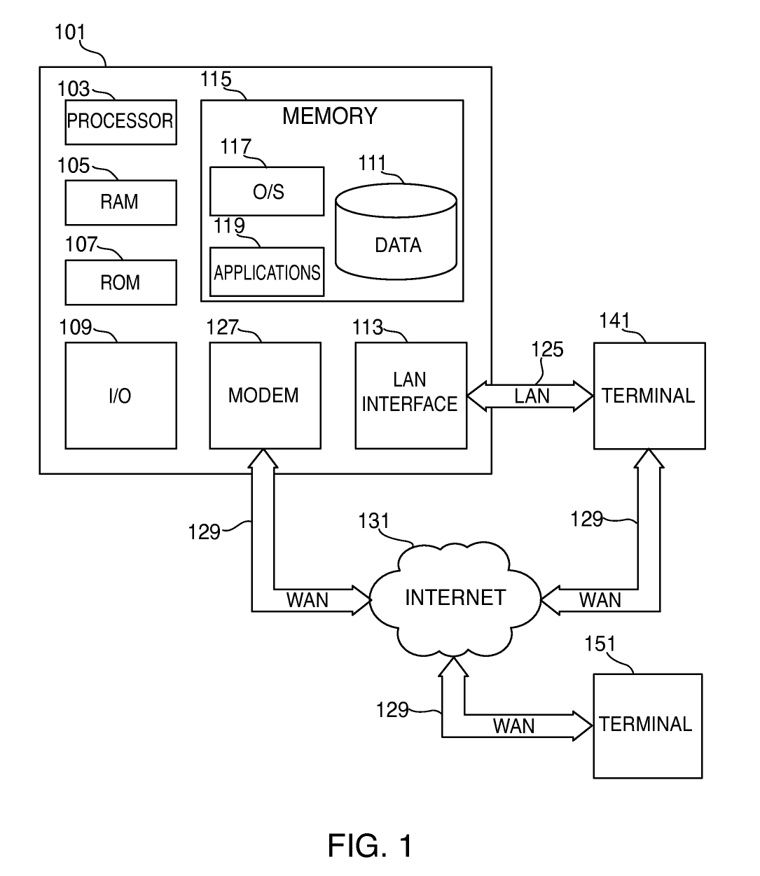

FIG. 1 is an illustrative block diagram of mobile device system 100 based on a computer 101. The computer 101 may have a processor 103 for controlling the operation of the mobile device and its associated components, and may include RAM 105, ROM 107, input/output module 109, and a memory 115. The processor 103 will also execute all software running on the computer—e.g., the operating system. Other components commonly used for computers such as EEPROM or Flash memory or any other suitable components may also be part of the computer 101.

The memory 115 may be comprised of any suitable permanent storage technology—e.g., a hard drive. The memory 115 stores software including the operating system 117 any application(s) 119 along with any data 111 needed for the operation of the system 100. Alternatively, some or all of computer executable instructions may be embodied in hardware or firmware (not shown). The computer 101 executes the instructions embodied by the software to perform various functions.

Input/output (“I/O”) module may include connectivity to a microphone, keyboard, touch screen, and/or stylus through which a user of computer 101 may provide input, and may also include one or more speakers for providing audio output and a video display device for providing textual, audiovisual and/or graphical output.

System 100 may be connected to other mobile device systems via a LAN interface 113.

System 100 may operate in a networked environment supporting connections to one or more remote computers, such as terminals 141 and 151. Terminals 141 and 151 may be personal computers or servers that include many or all of the elements described above relative to mobile device system 100. The network connections depicted in FIG. 1 include a local area network (LAN) 125 and a wide area network (WAN) 129, but may also include other networks. When used in a LAN networking environment, computer 101 is connected to LAN 125 through a LAN interface or adapter 113. When used in a WAN networking environment, computer 101 may include a modem 127 or other means for establishing communications over WAN 129, such as Internet 131.

It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, application program(s) 119, which may be used by computer 101, may include computer executable instructions for invoking user functionality related to communication, such as email, Short Message Service (SMS), and voice input and speech recognition applications.

Computer 101 and/or terminals 141 or 151 may also be mobile devices including various other components, such as a battery, speaker, and antennas (not shown).

Terminal 151 and/or terminal 141 may be portable devices such as a laptop, cell phone, Blackberry™, or any other suitable device for storing, transmitting and/or transporting relevant information. Terminals 151 and/or terminal 141 may be other mobile devices. These mobile devices may be identical to mobile device system 100 or different. The differences may be related to hardware components and/or software components.

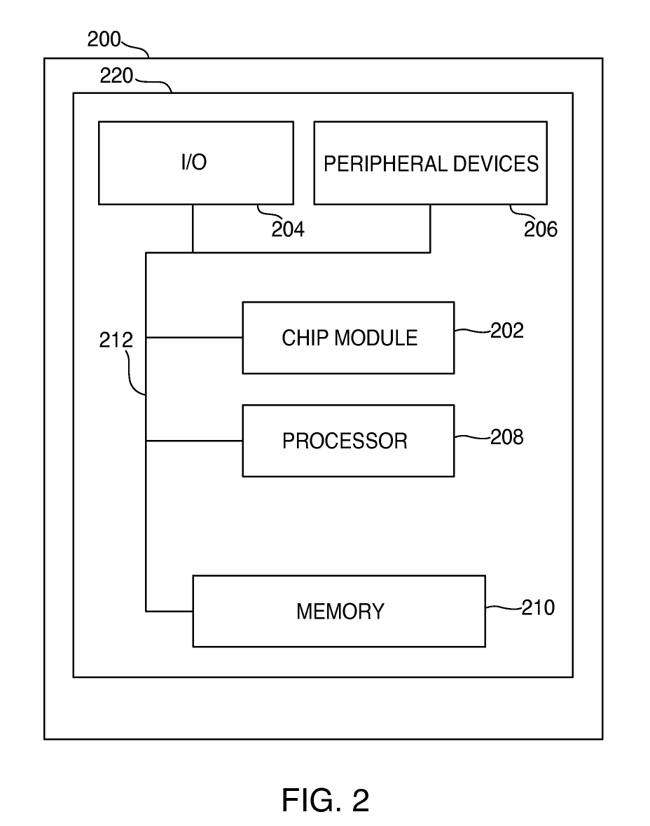

FIG. 2 shows illustrative apparatus 200. Apparatus 200 may be a computing machine. Apparatus 200 may include one or more features of the apparatus shown in FIG. 1. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable encoded media or devices; peripheral devices 206, which may include counter timers, real-time timers, power-on reset generators or any other suitable peripheral devices; logical processing device 208, which may compute data structural information, structural parameters of the data, compress files; and machine-readable memory 210.

Machine-readable memory 210 may be configured to store in machine-readable data structures: entity-specific standards, installation instructions, executable setup files, software applications, customized computer-readable scripts, the current time and any other suitable information or data structures.

Components 202, 204, 206, 208 and 210 may be coupled together by a system bus or other interconnections 212 and may be present on one or more circuit boards such as 220. In some embodiments, the components may be integrated into a single chip. The chip may be silicon-based.

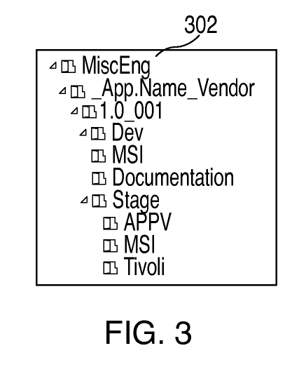

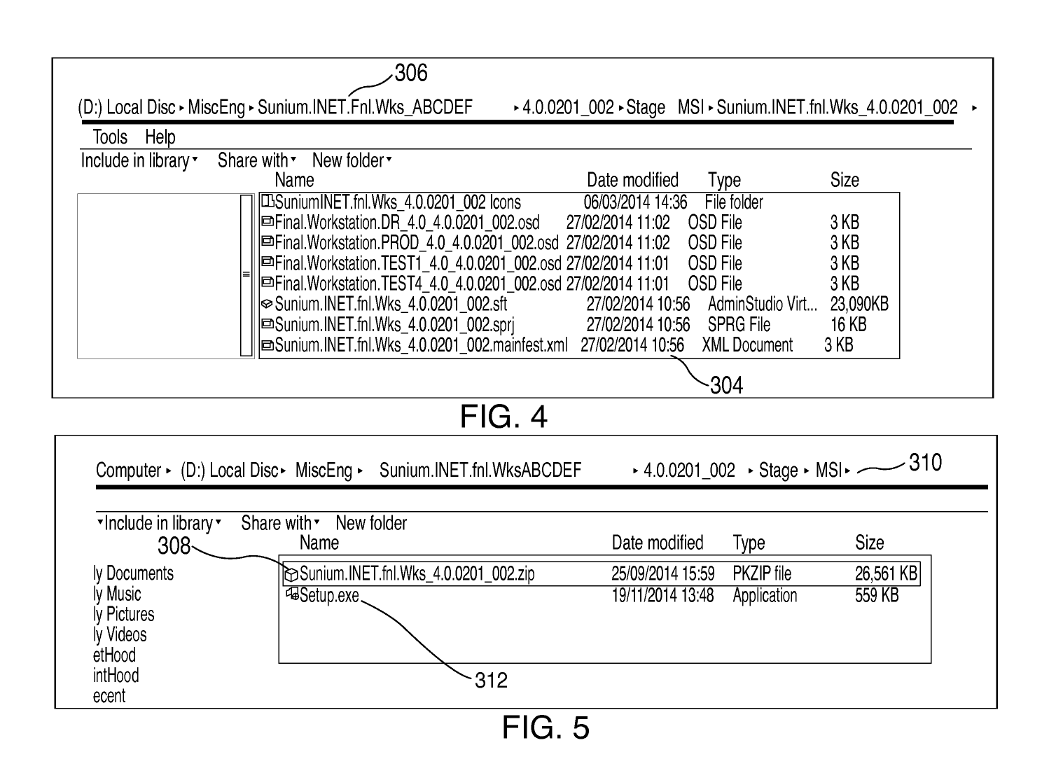

FIGS. 3-5 show exemplary file structure creation for a software application. An engineer may copy a default folder structure to an exemplary drive D:\MiscEng, as shown at 302 in FIG. 3. Under an MSI folder (.msi file extension refers to windows installer files), an engineer may create a folder with the naming convention “ApplicationName_Version_Build”. An engineer may copy resource files, for example, .sft, .osd, .xml, .spri, and any other suitable resource files, as shown at 304 in FIG. 4, into the ApplicationName_Version_Build file, which may be Sunium.INET.fnl.Wks_ABCDEF\4.0.0201_002\Stage\MSI as shown in at 306 in FIG. 4.

An engineer may zip the ApplicationName_Version_Build file. The filename of the zipped file may be “ApplicationName_Version_Build.zip”, as shown at 308 in FIG. 5. The zipped file may be saved in the MSI folder, as shown at 310 in FIG. 5. A setup.exe file may also be stored in the MSI folder, as shown at 312, in FIG. 5. It should be appreciated that the setup.exe file is in the same folder as the .zip file so that upon execution of the setup.exe file the zip file may be extracted and then removed and then the installation can start.

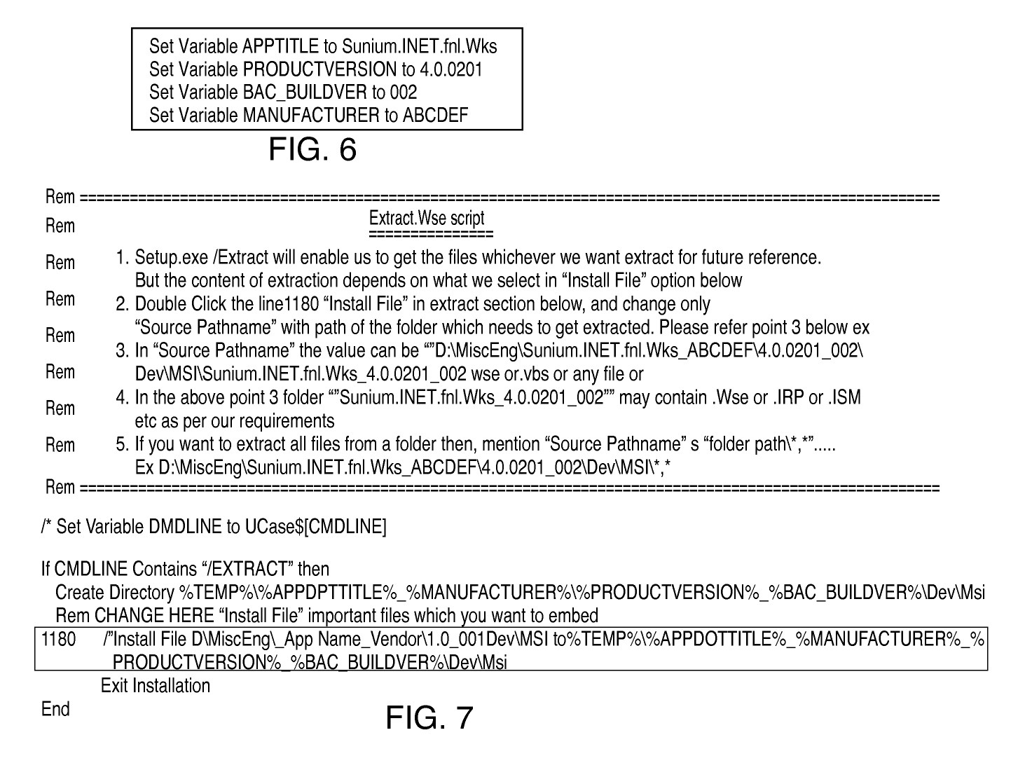

FIGS. 6-16 show exemplary computer-readable scripts which may enable a computer to perform steps described above.

FIG. 6 shows exemplary variable declaration. For example, set the variable APPTITLE (Application Title) to “SuniumINET.fnl.Wks”.

FIG. 7 shows exemplary extraction of files from the package. When the CLI receives “extract” as a parameter to a setup.exe file, the computer-readable script may create a directory to store the file. The computer-readable script may install the indicated file in the correct folder.

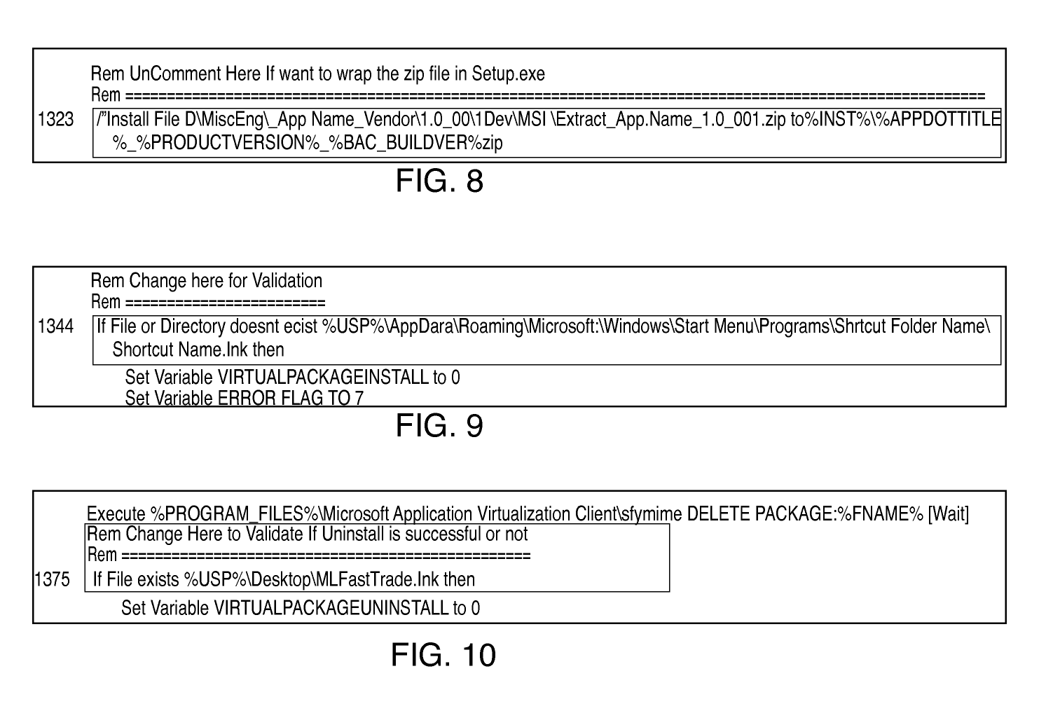

FIG. 8 shows exemplary wrapping of a .zip folder into a setup.exe file. In some embodiments, when required, the .zip folder may be included in the setup.exe file. In other embodiments, the .zip file may be included in the file which stores the setup.exe file. For example, line 1323 shows installing a .zip file, which may be included in a setup.exe file for the application. The .zip file may be wrapped into the setup.exe file of the application. The .zip file may be copied into the same folder as the setup.exe file as per the application requirements. The application requirements may be that the setup.exe is included in the same folder as the .zip file. Including the .zip file in the same folder as the setup.exe may enable the setup.exe to extract the .zip file during installation, or any other suitable time.

FIG. 9 shows an exemplary shortcut creation after successful installation. Line 1344 checks whether the virtual application installation was successful or unsuccessful. The checking may be done with a validation check.

FIG. 10 shows validation of successful installation. The computer-readable script performs a validation check if an uninstallation was successful. If the shortcut files for the software application do not exist, the variable “virtual package uninstall” may be set to zero, which may be understood to mean that the uninstallation was successful.

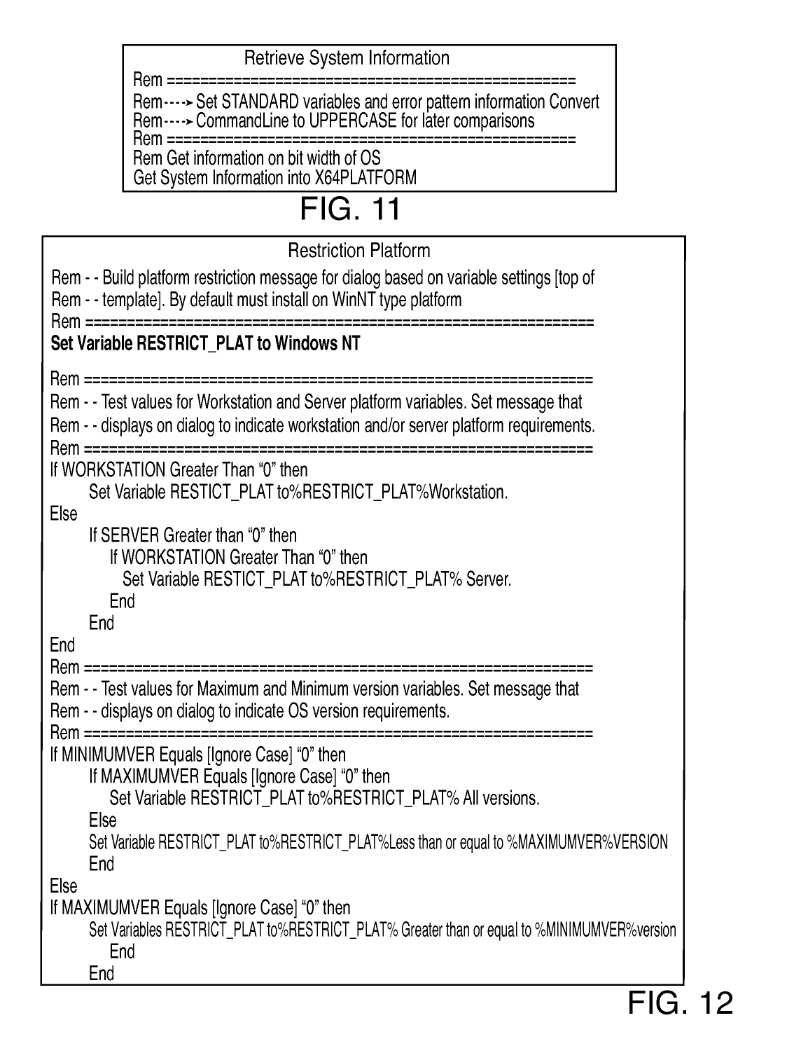

FIG. 11 shows retrieving system information. The computer-readable script may retrieve system information to assess the capabilities of the operating system.

FIG. 12 shows a restriction platform. The restriction platform may test different values. The values may determine workstation requirements and/or server platform requirements. The restriction platform may also test maximum and minimum version variables. Based on the testing, the computer-readable code may set the restriction platform variable. The restriction platform may determine the versions of the application with which the system can operate.

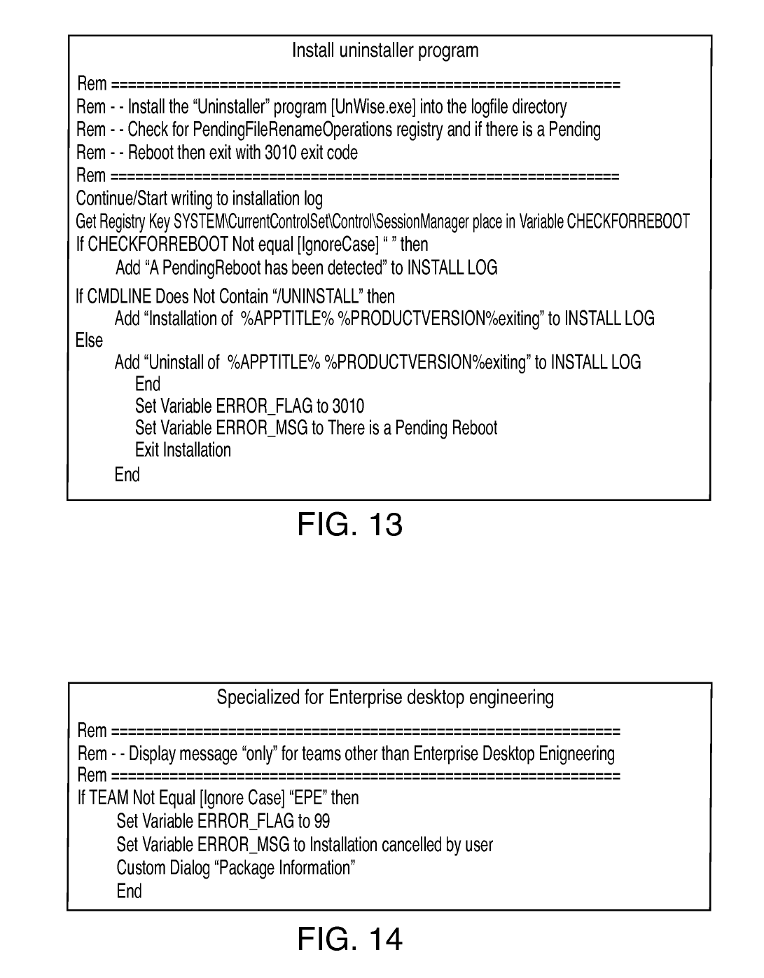

FIG. 13 shows checking, prior to performing installation, whether there is a pending reboot on any machine. If there is a pending reboot, the computer-readable script may exit installation instead of continuing with the installation.

FIG. 14 shows customizing the display for specific teams, or company departments. FIG. 14 shows that if the team is not Enterprise Desktop Engineering (“EPE”), the system should not enable installation of an application by a user.

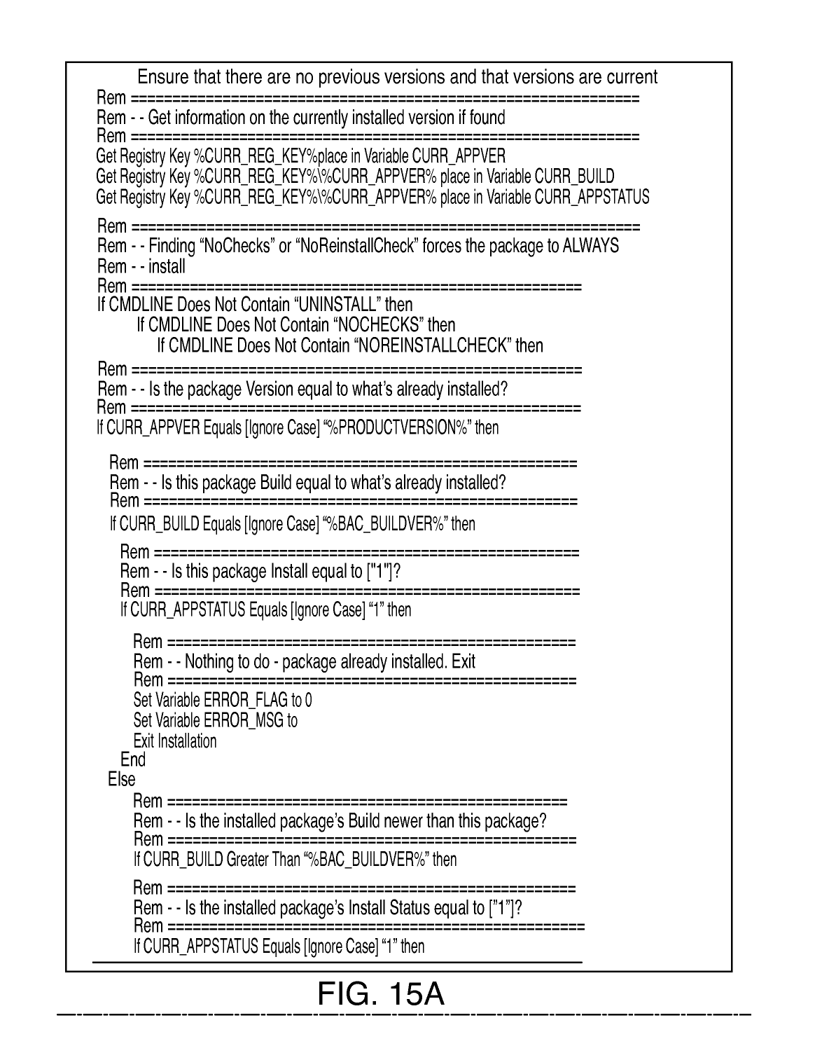

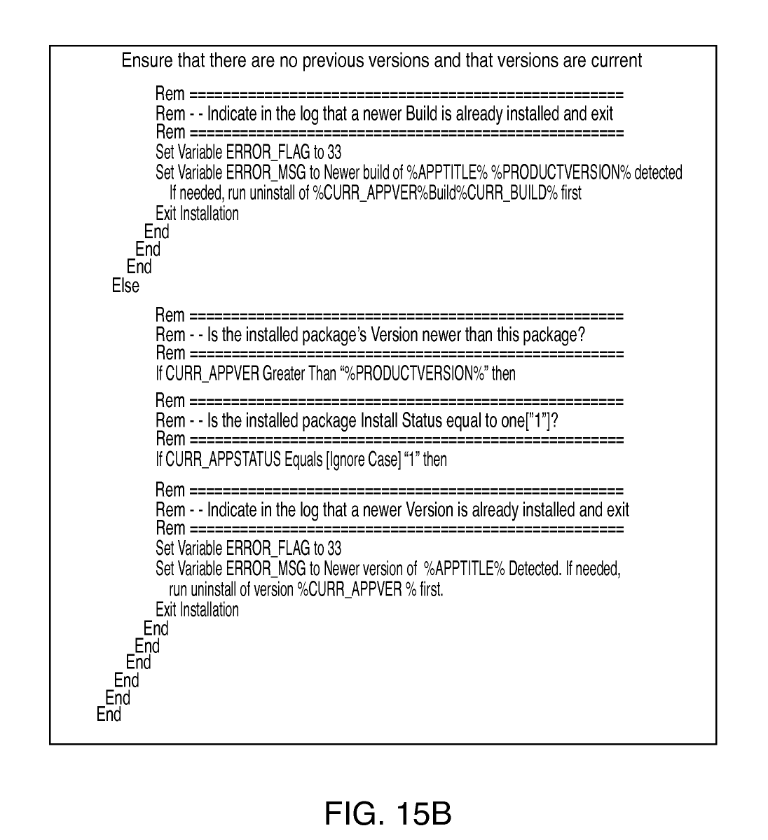

FIGS. 15A and 15B show validation to ensure that no previous versions are available on the computer. FIGS. 15A and 15B also show validation to ensure that the versions being installed are current.

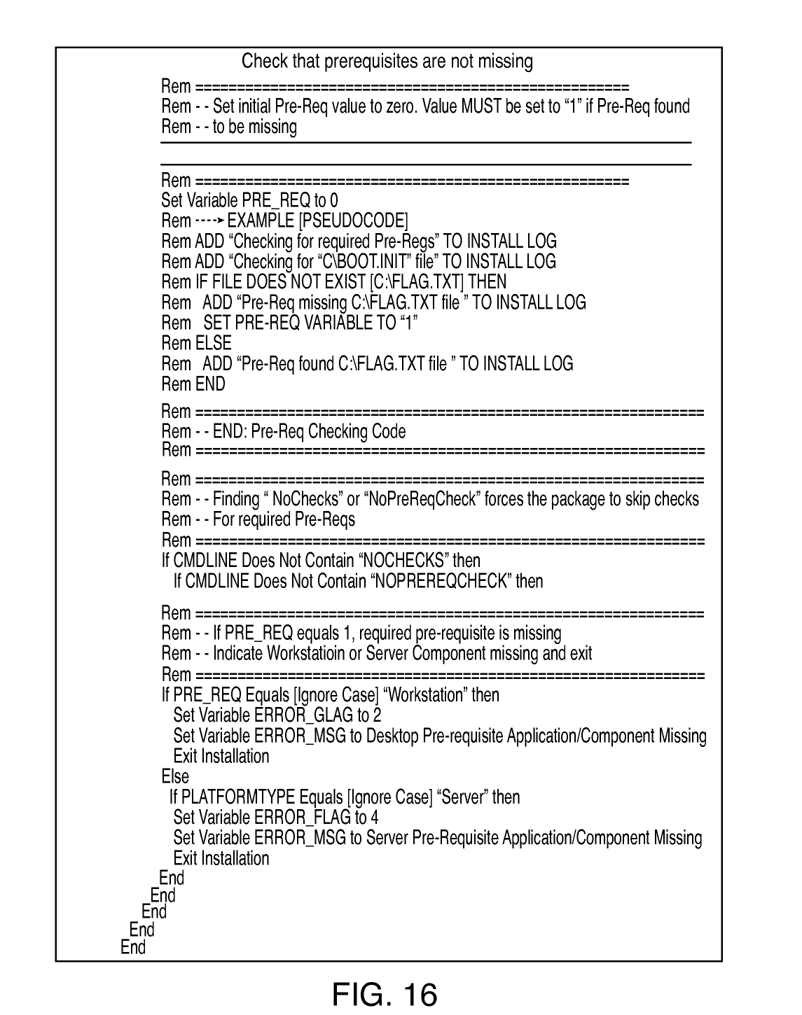

FIG. 16 shows checking that the perquisites necessary for the application are installed on the computer.

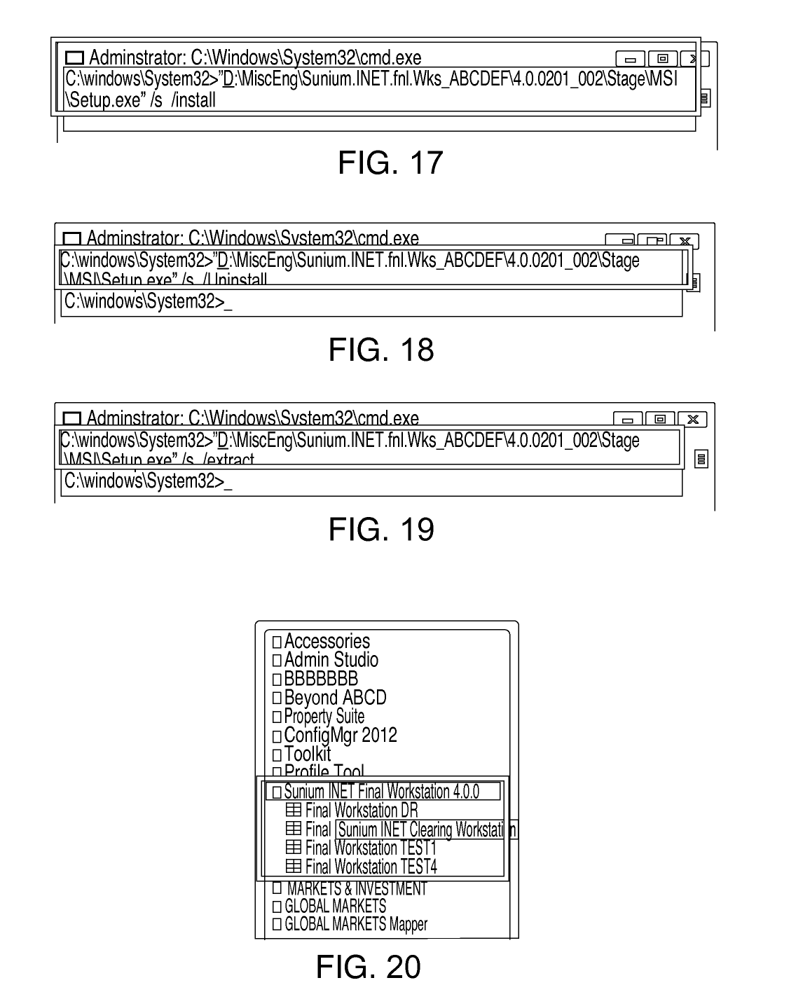

FIG. 17 shows a user entered “install” as a parameter into the setup.exe on the command line interface.

FIG. 18 shows a user entered “uninstall” as a parameter into the setup.exe on the command line interface

FIG. 19 shows a user entered “extract” as a parameter into the setup.exe on the command line interface.

It should be noted that, although the “install”, “uninstall” and “extract” parameters referred to in FIGS. 17, 18 and 19 are illustrated as being passed to a setup.exe for an .msi application, the parameters may be passed to a setup.exe for a virtual application, legacy executable application or any other suitable application.

FIG. 20 shows shortcuts for the application “Sunium INET Final Workstation” created under a start menu.

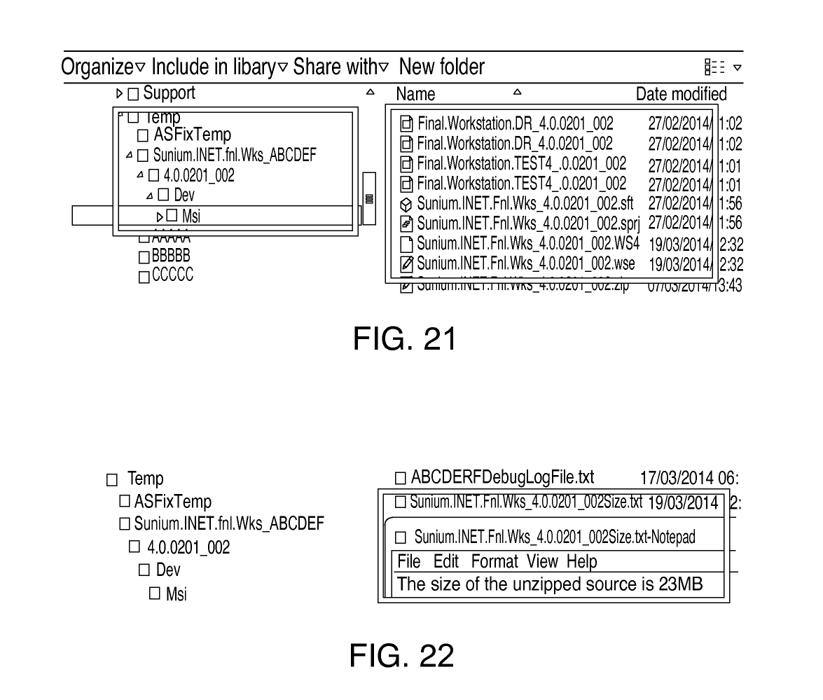

FIG. 21 shows the files which may have been extracted by the extract parameter shown in FIG. 19. As is shown, the files may be extracted into an “Msi” folder included in the “Temp” folder.

FIG. 22 shows a file may be created by the computer-readable script. The file may be a text log file. The text log file may include information pertaining to the size of the application folder before it is zipped. The log file may read “The size of the unzipped source is 23 MB”. Zipping, or file compression may enable the application to consume less disk space. The difference in the disk space may be approximately 20 percent. The compressed folders may be installed and staged in shorter periods of time. The reduction in installation and staging time may reduce network traffic reduce processor cycles required to install the application.

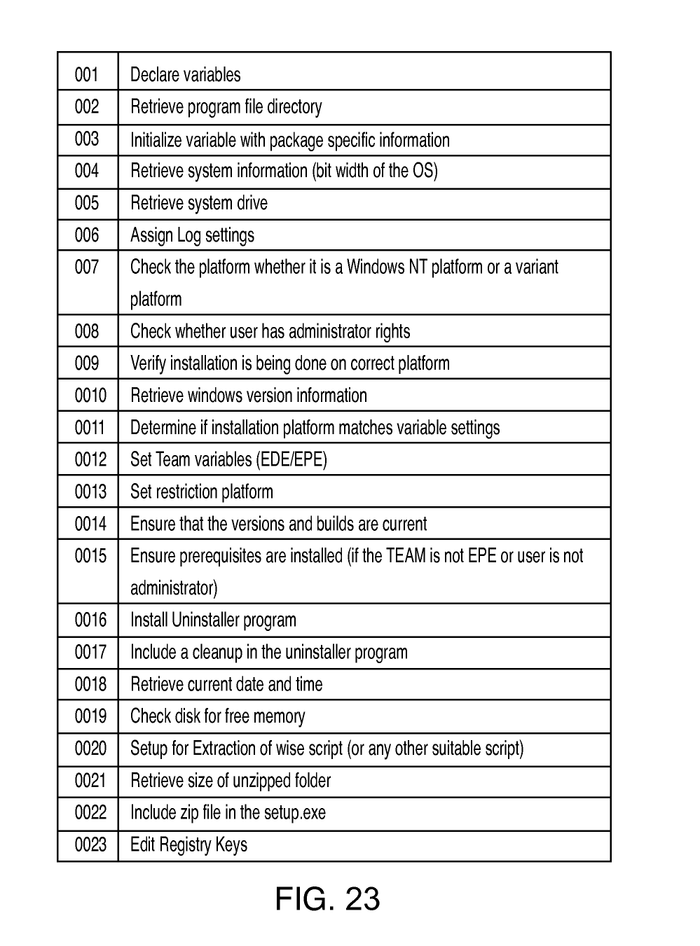

FIG. 23 shows pseudo-code which may correspond to part of the packaging system as described above. It should be appreciated that the order of the instructions are merely illustrative, and one skilled in the art will appreciate that the instructions can be performed in numerous orders other than those described below. In addition, it should also be appreciated that the computer-readable code can be written in numerous computer-readable languages including, but not limited to WiseScript, JavaScript, Java, C#, C++, Python, Perl and any other suitable computer-readable language.

Line 001 of FIG. 23 shows declaration of variables. The variables may be included in the computer-readable script. Line 002 shows retrieval of a program file directory. The application may be installed in the program file directory. Line 003 shows initializing variables with package specific information. The package specific information may include information relating to the application. Line 004 shows retrieving system information. The system information may be a bit width of the Operating System. The system information may be any other suitable system information. Line 005 shows retrieving system drive. The system drive may be a location where the application may be stored.

Line 006 shows assigning of log settings. The log settings may be references to a file where log information may be stored. Line 007 shows checking the platform. The platform may be a Windows NT platform or a variant platform. Line 008 shows checking whether a user has administrator right. If a user does not have administrator rights, the program may not allow the installation to continue. Line 009 shows verification that the installation is being performed on the correct platform. Line 0010 shows retrieval of Windows version information. Line 0011 shows determination if the installation platform matches the variable settings. Line 0012 shows setting of the team variables. The team variables may be groups or teams within an entity. Teams may include EDE, EPE or any other suitable teams.

Line 0013 shows setting the restriction platform. Line 0014 shows ensuring that the versions and the builds are correct. Line 0015 shows ensuring that the prerequisites are installed. The prerequisites may only need to be installed in the team is not EPE. The prerequisites may also need to be installed if the user in not an administrator. Line 0016 shows installing the uninstaller program. Line 0017 shows inclusion of a cleanup program in the uninstaller program. The cleanup may remove access information, files, shortcuts or any data that the installation entered into a computer.

Line 0018 shows retrieval of the current date and/or time. Line 0019 shows checking the disk for free memory. Free memory may be required for the installation. Line 0020 shows setup for, or enabling extraction of the script. The script may be embedded in the program so that it can be retrieved at any suitable time. The script may a Wise Script (.wse), any other suitable script, an important configuration file or a file with important notes for future reference.

Line 0021 shows retrieving the size of the unzipped folder. Line 0022 shows inclusion of the zip file in the seutup.exe file. Line 0023 shows editing of the registry keys. The registry keys may enable or disable registry settings in an application or a computer in general.

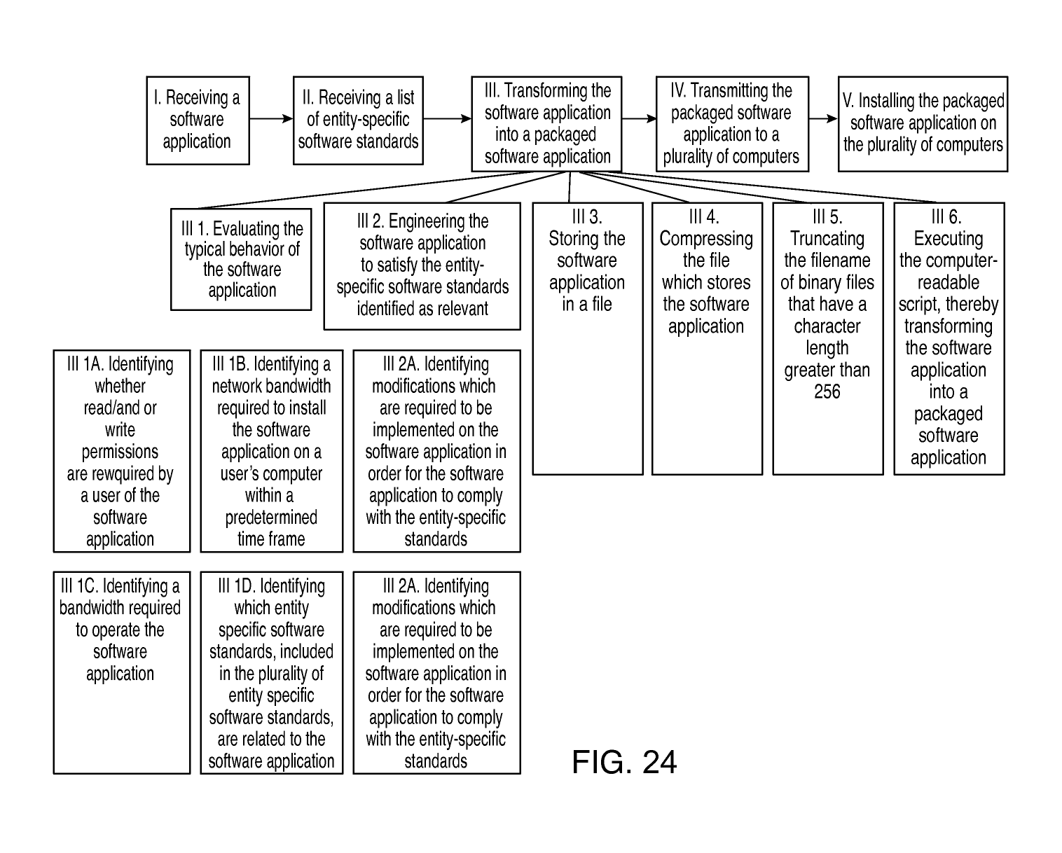

FIG. 24 shows an illustrative flow chart of the packaging system. Step I shows receiving a software application. Step II shows receiving a list of entity-specific software standards. A packaging system may include a standardized template of entity-specific software standards. In embodiments where a standardized template is included in the packaging system, step II may include receiving specific requirements, customizations and/or customization standards. Step III shows transforming the software application into a packaged software application. Step III may include step III 1. Step III 1 may evaluate the behavior of the software application. Step III 1 may include steps III 1A, III 1B, III 1C, III 1D and any other suitable steps. Step III 1A may identify whether read and/or write permissions are required by a user of software application. Step III 1B may identify a network bandwidth required to install the software application on a user's computer within a predetermined time frame. Step III 1C may identify system requirements required to operate the software application. Step III 1D may identify which entity-specific software standards, included in the plurality of entity-specific software standards, are related to the software application.

Step III may include step III 2. Step III 2 may engineer the software application to satisfy the entity-specific software standards identified as relevant. Step III 2 may include steps III 2A, III 2B and any other suitable steps. Step III 2A may identify modifications which are required to be implemented on the software application to cause the software application to comply with the entity-specific standards. Step III 2B may generate a computer-readable script. When executed, the computer-readable script may modify the software application, and thereby conform the software application to the entity-specific standards.

Step III may also include steps III 3, III 4, III 5, III 6 and any other suitable steps. Step III 3 may store the software application in a file.

Step III 4 may compress the file which stores the software application. Step III 5 may truncate the filename of binary files that have a character length greater than 256. Step III 6 may execute the computer-readable script, thereby transforming the software application into a packaged software application.

Step IV may transmit the packaged software application to a plurality of computers. Step V may install the packaged software application on the plurality of computers. The installation may be executed remotely, via a network, intranet, Internet or any other suitable system.

As will be appreciated by one of skill in the art, the invention described herein may be embodied in whole or in part as a method, a data processing system, or a computer program product. Accordingly, the invention may take the form of an entirely hardware embodiment, an entirely software embodiment or an embodiment combining software, hardware and any other suitable approach or apparatus.

Furthermore, such aspects may take the form of a computer program product stored by one or more computer-readable storage media having computer-readable program code, or instructions, embodied in or on the storage media. Any suitable computer-readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

The invention may be described in the general context of computer-executable instructions, such as program modules, being executed by a computer. Generally, program modules may include routines, programs, objects, components, data structures, etc., that perform particular tasks or store or process data structures, objects and other data types. The invention may also be practiced in distributed computing environments where tasks are performed by separate (local or remote) processing devices that are linked through a communications network.

In a distributed computing environment, program modules may be located in both local and remote computer storage media including memory storage devices. In a distributed computing environment, devices that perform the same or similar function may be viewed as being part of a “module” even if the devices are separate (whether local or remote) from each other.

Thus, methods and apparatus for a software application packaging and deployment system are provided. Persons skilled in the art will appreciate that the present invention can be practiced by other than the described embodiments, which are presented for purposes of illustration rather than of limitation, and that the present invention is limited only by the claims that follow.

What is claimed is:

1. An apparatus for packaging application software, the apparatus comprising:
a receiver configured to receive:
a software application; and
a list of entity-specific software standards;
a packaging system for transforming the software application into a packaged software application, the transforming comprising:
evaluating the behavior of the software application, the evaluating comprising:
identifying whether read and/or write permissions are required by a user of the software application;
identifying a network bandwidth required to install the software application on the user's computer within a predetermined time frame;
identifying system requirements required to operate the software application;
identifying which entity-specific software standards, included in the plurality of entity-specific software standards, are related to the software application;
engineering the software application to satisfy the entity-specific software standards identified as relevant, the engineering comprising:
identifying a plurality of modifications which are required to be implemented on the software application in order for the software application to comply with the entity-specific standards;
generating a computer-readable script, which when executed, modifies the software application, and thereby conforms the software application to the entity-specific standards;
storing the software application in a file;
compressing the file which stores the software application;
truncating the filename of binary files included in the software application file, said binary files comprising a file name that has a character length greater than 256; and
executing the computer-readable script, thereby transforming the software application into a packaged software application;
a transmitter configured to transmit the packaged software application to a plurality of desktop computers, wherein the plurality of desktop computers are each located in a remote location with respect to the packaging system;
one or more processors configured to install, transparent to a user, the packaged software application on the plurality of desktop computers.

2. The apparatus of claim 1, wherein the plurality of modifications comprise a plurality of registry changes.

3. The apparatus of claim 2, wherein the plurality of registry changes comprise at least one of the group consisting of lockdown of registry settings, policy changes and licensing changes.

4. The apparatus of claim 1, wherein the installation comprises an executable setup file, wherein the executable setup file is accessible via the command line interface.

5. The apparatus of claim 4, wherein:
the installation is prompted via the executable setup file; and
the installation comprises placement of a shortcut icon on each desktop computer, included in the plurality of client desktop computers, said shortcut icon that enables a user of the packaged software application to initialize the packaged software application via a selection of the shortcut icon.

6. The apparatus of claim 4, wherein the packaging system uninstalls the packaged software application via the executable setup file on the command line interface.

7. The apparatus of claim 1, wherein the packaging system further comprises storing the computer-readable script in an extractable folder in the software application.

8. The apparatus of claim 7, wherein the packaging system further comprises enabling a user to extract the computer-readable script from the software application, in the event that the software application becomes corrupted.

9. The apparatus of claim 7, wherein the packaging system further comprises enabling a user to extract the computer-readable script from the software application, in the event that the software application requires an update.

10. The apparatus of claim 4, wherein:
the executable setup file accepts parameters on the command line interface;
the parameters comprise install, uninstall and extract;
upon receipt of the parameter install by the executable setup file on the command line interface, the executable file is configured to execute an installation computer-readable script which, when executed, installs the software application on a desktop computer;
upon receipt of the parameter uninstall by the executable setup file on the command line interface, the executable file is configured to execute an uninstallation computer-readable script, which when executed, uninstalls the software application on the desktop computer;
upon receipt of the parameter extract by the executable setup file on the command line interface, the executable setup file is configured to execute an extraction computer-readable script which, when executed, extracts the computer-readable script from the packaged software application.

11. A method for packaging application software, the method comprising:
receiving a software application;
receiving a list of entity-specific software standards;
transforming, at a packaging system, the software application into a packaged software application, the transforming comprising:
evaluating the behavior of the software application, the evaluating comprising:
identifying whether read and/or write permissions are required by a user of the software application;
identifying a network bandwidth required to install the software application on the user's computer within a predetermined time frame;
identifying system requirements required to operate the software application;
identifying which entity-specific software standards, included in the plurality of entity-specific software standards, are related to the software application;
engineering the software application to satisfy the entity-specific software standards identified as related to the software application, the engineering comprising:
identifying a plurality of modifications which are required to be implemented on the software application in order for the software application to comply with the entity-specific standards;
generating a computer-readable script, which, when executed, modifies the software application, and thereby conforms the software application to the entity-specific standards;
storing the software application in a file;
compressing the file which stores modified and conforming the software application;
truncating the file names of binary files included in the software application file, said binary files comprising a filename that has a character length greater than 256;
executing the computer-readable script, thereby transforming the software application into a packaged software application;
transmitting the packaged software application to a plurality of desktop computers, wherein the plurality of desktop computers are each located in a remote location with respect to the packaging system;
installing, transparent to a user, the packaged software application to the plurality of desktop computers.

12. The method of claim 11, wherein the plurality of modifications comprise registry changes.

13. The method of claim 12, wherein the registry changes comprise at least one of the group consisting of lockdown of registry settings, policy changes and licensing changes.

14. The method of claim 11, wherein the installing comprises an executable setup file, wherein the executable setup file is accessible via a command line interface.

15. The method of claim 14, wherein:
the installing is initiated via the executable setup file;
the installing further comprises placement of a shortcut icon on each desktop computer included in the plurality of client desktop computers, said shortcut icon that enables a user of the packaged software application to initialize the packaged software application via a selection of the shortcut icon.

16. The method of claim 14, further comprising uninstallation, by the packaging system, of the packaged software application via the executable setup file on the command line interface.

17. The method of claim 11, further comprising storing, by the packaging system, the computer-readable script in an extractable folder in the software application.

18. The method of claim 17, further comprising enabling, by the packaging system, a user to extract the computer-readable script from the software application, in the event that the software application becomes corrupted.

19. The method of claim 17, further comprising enabling, by the packaging system, a user to extract the computer-readable script from the software application, in the event that the software application requires an update.

20. The method of claim 14 further comprising enabling the executable setup file to accept parameters on the command line interface, the parameters comprising install, uninstall and extract, wherein:
upon receipt of the parameter install by the executable setup file on the command line interface, the executable setup file is configured to execute an installation computer-readable script which, when executed, installs the software application on a desktop computer;
upon receipt of the parameter uninstall by the executable setup file on the command line interface, the executable setup file is configured to execute an uninstallation computer-readable script, which when executed, uninstalls the software application on the desktop computer; and
upon receipt of the parameter extract by the executable setup file on the command line interface, the executable setup file is configured to execute an extraction computer-readable script which, when executed, extract the computer-readable script from the packaged software application.
